(19) United States
(12) Patent Application Publication
(10) Pub. No.: US 2024/0236867 A1
(43) Pub. Date: Jul. 11, 2024

(54) INFORMATION TRANSMISSION METHOD, APPARATUS, NODE, AND STORAGE MEDIUM

(71) Applicant: ZTE Corporation, Shenzhen (CN)

(72) Inventors: Ting MIAO, Shenzhen (CN); Youxiong LU, Shenzhen (CN); Weimin XING, Shenzhen (CN); Feng BI, Shenzhen (CN); Jie CHEN, Shenzhen (CN)

(73) Assignee: ZTE Corporation, Shenzhen (CN)

(21) Appl. No.: 18/430,026

(22) Filed: Feb. 1, 2024

Related U.S. Application Data
(63) Continuation of application No. PCT/CN2022/120411, filed on Sep. 22, 2022.

(30) Foreign Application Priority Data
Aug. 4, 2021 (CN) 202110891847.3

(51) Int. Cl. H04W 52/14; H04W 52/36; H04W 72/0446

(52) U.S. Cl. CPC H04W 52/146; H04W 52/367; H04W 72/0446

(57) ABSTRACT

Provided are an information transmission method and apparatus, a node, and a storage medium. The information transmission method is applied to a first node and includes: determining power control assistance information (S110); and transmitting the power control assistance information (S120); where the power control assistance information includes first power control assistance information, and the first power control assistance information includes an expected transmit power spectral density.

### CROSS-REFERENCE TO RELATED APPLICATION

This application claims the benefit of priority under 35 U.S.C. § 120 as a continuation of PCT Patent Application No. PCT/CN2022/120411, filed on Sep. 22, 2022, which claim priority to CN Application No. 202110891847.3, filed on Aug. 4, 2021, the disclosure of each of these is incorporated herein by reference in its entirety.

### TECHNICAL FIELD

The present application relates to the field of communication technology, for example, an information transmission method and apparatus, a node, and a storage medium.

### BACKGROUND

In an integrated access and backhaul (IAB) network, a node having a wired backhaul link with a core network is a donor IAB (IAB-donor). The donor IAB consists of one central unit (CU) and one or more distributed units (DUs). A node that is wirelessly connected to the donor IAB (or an upper layer IAB node) is an IAB node. The IAB network can support multi-hop, and logical interfaces/connections exist between the CU and the mobile termination (MT) and DU of the IAB node on each layer. No direct connection exists between the IAB node and the core network, and the interaction of the IAB node with the core network needs to be accomplished through one or more forwarding and with the help of the donor IAB. Both the donor IAB and the IAB node support access to a terminal.

Depending on capability, the MT and the DU of the IAB node may work in a time-division multiplexing manner or may work simultaneously in a frequency-division multiplexing manner or a space-division multiplexing manner. The IAB node has a variety of multiplexing manners, and the power control is thus complicated. No effective solution to how to effectively assist a parent node to perform power control on the MT of the IAB node has been proposed.

### SUMMARY

The present application provides an information transmission method and apparatus, a node, and a medium to assist a second node to perform power control on a first node.

In a first aspect, an embodiment of the present application provides an information transmission method. The method is applied to a first node and includes the following steps.

Power control assistance information is determined, and the power control assistance information is transmitted; where the power control assistance information includes first power control assistance information, and the first power control assistance information includes an expected transmit power spectral density.

In a second aspect, an embodiment of the present application provides an information transmission method. The method is applied to a second node and includes the following steps.

First power control assistance information included in power control assistance information is acquired, and power control is performed on a first node.

In a third aspect, an embodiment of the present application provides an information transmission method. The method is applied to a first node and includes the following steps.

Power control assistance information is determined, and the power control assistance information is transmitted; where the power control assistance information includes second power control assistance information.

In a fourth aspect, an embodiment of the present application provides an information transmission method. The method is applied to a second node and includes the following.

Second power control assistance information included in power control assistance information is acquired, and power control is performed on a first node.

In a fifth aspect, an embodiment of the present application provides an information transmission apparatus. The apparatus is configured in a first node and includes a determination module and a transmission module.

The determination module is configured to determine power control assistance information, and the transmission module is configured to transmit the power control assistance information; where the power control assistance information includes first power control assistance information, and the first power control assistance information indicates an expected transmit power spectral density.

In a sixth aspect, an embodiment of the present application provides an information transmission apparatus. The apparatus is configured in a second node and includes an acquisition module and a control module.

The acquisition module is configured to acquire first power control assistance information included in power control assistance information, and the control module is configured to perform power control on a first node.

In a seventh aspect, an embodiment of the present application provides an information transmission apparatus. The apparatus is configured in a first node and includes a determination module and a transmission module.

The determination module is configured to determine power control assistance information, and the transmission module is configured to transmit the power control assistance information; where the power control assistance information includes second power control assistance information.

In an eighth aspect, an embodiment of the present application provides an information transmission apparatus. The apparatus is configured in a second node and includes an acquisition module and a control module.

The acquisition module is configured to acquire second power control assistance information included in power control assistance information, and the control module is configured to perform power control on a first node.

In a ninth aspect, an embodiment of the present application provides a node. The node includes one or more processors and a storage apparatus configured to store one or more programs, where the one or more programs, when executed by the one or more processors, cause the one or more processors to implement the information transmission method provided in the embodiments of the present application.

In a tenth aspect, an embodiment of the present application provides a storage medium. The storage medium is configured to store a computer program, where the computer program, when executed by a processor, implements the information transmission method provided in the embodiments of the present application.

### BRIEF DESCRIPTION OF DRAWINGS

FIG. 1 is a flowchart of an information transmission method according to an embodiment of the present application;

FIG. 2 is a schematic diagram of an IAB node scenario according to an embodiment of the present application;

FIG. 3 is a flowchart of another information transmission method according to an embodiment of the present application;

FIG. 4a is a flowchart of another information transmission method according to an embodiment of the present application;

FIG. 4b is a flowchart of yet another information transmission method according to an embodiment of the present application;

FIG. 5 is a structure diagram of an information transmission apparatus according to an embodiment of the present application;

FIG. 6 is a structure diagram of another information transmission apparatus according to an embodiment of the present application;

FIG. 7a is a structure diagram of another information transmission apparatus according to an embodiment of the present application;

FIG. 7b is a structure diagram of yet another information transmission apparatus according to an embodiment of the present application; and

FIG. 8 is a structure diagram of a node according to an embodiment of the present application.

### DETAILED DESCRIPTION

Embodiments of the present application are described below in conjunction with drawings.

The steps illustrated in the flowcharts among the drawings may be performed by, for example, a computer system capable of executing a set of computer-executable instructions. Moreover, although logical sequences are illustrated in the flowcharts, in some cases, the illustrated or described steps may be performed in sequences different from those described herein.

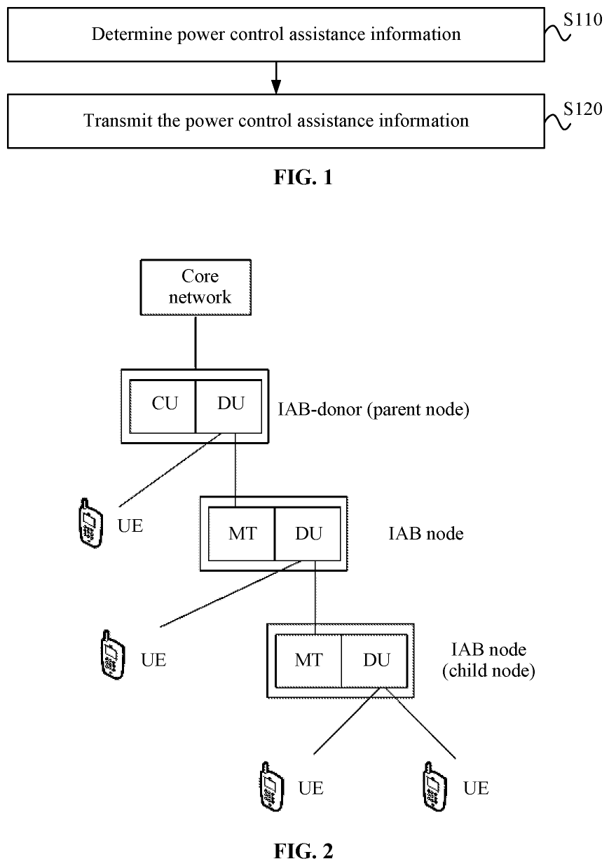

In an example implementation, FIG. 1 is a flowchart of an information transmission method according to an embodiment of the present application. The method is suitable for assisting in performing power control. The method may be executed by an information transmission apparatus. The apparatus may be implemented by software and/or hardware and integrated into a first node. The first node may be considered as a first communication node, such as an IAB node.

FIG. 2 is a schematic diagram of an IAB node scenario according to an embodiment of the present application. As shown in FIG. 2, the IAB node supports part of the functions of a user equipment (UE), and such an IAB node may be referred to as an IAB-MT. The IAB-MT is wirelessly connected to an upper layer node (or referred to as a parent node) to achieve backhaul. The parent node may be an IAB node, a donor IAB node or a base station. The IAB node also supports the functions of a next-generation NodeB (gNB)-DU (which is referred to as an IAB-DU) and can serve an ordinary UE and an IAB node (which is referred to as a child node). The link between the IAB node and the parent node is referred to as a backhaul link, and the link between the IAB node and the child node or the UE is referred to as an access link. Depending on capability, the IAB-MT and IAB-DU of the IAB node may work in a time-division multiplexing manner or may work simultaneously in a frequency-division multiplexing manner or a space-division multiplexing manner. The simultaneous working mainly includes the following four schemes: 1) Scheme A: IAB-MT transmission and IAB-DU transmission work simultaneously; 2) Scheme B: IAB-MT reception and IAB-DU reception work simultaneously; 3) Scheme C: IAB-MT reception and IAB-DU transmission work simultaneously; and 4) Scheme D: IAB-MT transmission and IAB-DU reception work simultaneously. No effective solution to which assistance information needs to be transmitted in different scenarios to assist the parent node (for example, a second node) to perform power control to reduce interference in the network and improve the transmission performance and communication quality of the IAB network has been proposed.

For the scenario where the IAB-MT and the IAB-DU perform transmission simultaneously (that is, Scheme A), the IAB-MT and the IAB-DU may need to share power, and therefore, the maximum transmit power of the IAB-MT and/or the IAB-DU may need to be reduced. For the scenario where the IAB-MT performs transmission and the IAB-DU performs reception (that is, Scheme D), the maximum transmit power of the IAB-MT may need to be reduced to reduce the interference of the transmission of the IAB-MT on the reception of the IAB-DU. Therefore, compared with the case where the IAB-MT and the IAB-DU work in the time-division multiplexing manner, the simultaneous working of IAB-MT and the IAB-DU may result in the reduction in the maximum transmit power of the IAB-MT. In addition, when the parent node of the IAB node performs simultaneous reception of the MT and the DU of the parent node, the uplink transmit power of the IAB-MT may need to be increased to balance the reception power of the two. To enable the DU of the parent node to perform accurate power control and make reasonable scheduling decisions, the parent node or a network side needs to know the expectation or requirement of the IAB node for the transmit power of the IAB-MT in different scenarios, that is, the IAB node (that is, the first node) needs to provide the power control assistance information of the uplink transmission of the backhaul link to assist the parent node or the network side to perform power control on the uplink transmission on the backhaul link of the IAB node.

To solve the problems described above, as shown in FIG. 1, the information transmission method provided by the present application includes S110 and S120.

In S110, power control assistance information is determined.

The power control assistance information may be considered as the information that assists the second node to perform power control on the first node, such as information for assisting in performing power control of an MT of the first node. The power control assistance information includes first power control assistance information, and the first power control assistance information includes an expected transmit power spectral density.

How to determine the power control assistance information is not limited in this embodiment, and different pieces of power control assistance information correspond to different determination means.

In an embodiment, the first power control assistance information is a power control parameter expected to be used by the MT of the first node.

In an embodiment, the first power control assistance information is a power control parameter expected to be used by a DU of the first node.

In S120, the power control assistance information is transmitted.

After the power control assistance information is determined, the power control assistance information may be transmitted. The power control assistance information may be transmitted to the second node, and the second node may be a parent node of the first node or may be a CU. The first node may also transmit the power control assistance information to both the parent node of the first node and the CU. Alternatively, the first node may transmit the power control assistance information to one of the parent node of the first node or the CU. Alternatively, the first node may transmit the power control assistance information to one of the parent node of the first node or the CU, and then the power control assistance information is transmitted by the one of the parent node of the first node or the CU to the other. For example, the power control assistance information is transmitted to the CU and then transmitted by the CU to the parent node of the first node, or the power control assistance information is transmitted to the parent node of the first node and then transmitted by the parent node of the first node to the CU. The alternatives are not limited here. The power control assistance information is transmitted to the second node to assist the second node to perform power control on the first node.

In the information transmission method provided by the present application, the power control assistance information is first determined, and then the power control assistance information is transmitted, where the power control assistance information includes first power control assistance information, and the first power control assistance information includes an expected transmit power spectral density. Through the method, the second node is effectively assisted to perform power control on the first node by transmitting the expected transmit power spectral density.

Based on the preceding embodiment, variant embodiments of the preceding embodiment are provided. For the brevity of description, only differences from the preceding embodiment are described in the variant embodiments.

In an embodiment, the expected transmit power spectral density includes one or more of: an expected transmit power per frequency unit or an expected transmit power range per frequency unit.

In an embodiment, a subcarrier spacing corresponding to the frequency unit is indicated by the first node or predefined.

The subcarrier spacing corresponding to the frequency unit may be included in the power control assistance information.

In an embodiment, the frequency unit includes one or more of: a resource block, a subcarrier, a frequency unit Hz, a resource block group, a subcarrier group, a bandwidth part (BWP), a physical channel, a physical signal, or a carrier.

In an embodiment, the power control assistance information further includes second power control assistance information, and the second power control assistance information includes one or more of:

a power headroom, a maximum transmit power, or headroom calculation indication information.

The headroom calculation indication information may be considered as the information indicating a power headroom calculation manner. The maximum transmit power may be used for calculating the power headroom.

In an embodiment, the power headroom is a maximum transmit power of the first node minus an estimated power for an uplink transmission, the power headroom is a maximum transmit power of an MT of the first node minus an estimated power for an uplink transmission, or the power headroom is the maximum transmit power included in the second power control assistance information minus an estimated power for an uplink transmission.

In an embodiment, the maximum transmit power of the first node is defined or specified in the protocol.

In an embodiment, the maximum transmit power of the MT of the first node is defined or specified in the protocol.

In an embodiment, the maximum transmit power included in the second power control assistance information is used for calculating the power headroom included in the second power control assistance information.

In an embodiment, the headroom calculation indication information is used for indicating a calculation manner of the power headroom included in the second power control assistance information, and the calculation manner includes calculating based on an actual transmission and calculating based on a reference format.

In an embodiment, the first power control assistance information further includes one or more of:
an expected transmit bandwidth, an expected transmit bandwidth range, an expected maximum transmit power, an expected transmit power, an expected transmit power range, an expected power adjustment amount, a power control process, or a transmit power of a DU of the first node.

In an embodiment, the expected power adjustment amount is associated with the power control process, and one expected power adjustment amount corresponds to one power control process.

In an embodiment, for each power control process, the parent node of the first node independently transmits a transmit power control (TPC) command to the first node.

In an embodiment, for each power control process, the first node maintains a local closed-loop power adjustment amount, and the closed-loop power adjustment amount is updated according to the TPC command.

The local closed-loop power adjustment amount is updated according to the TPC command in two manners, and the two manners are a cumulative manner and an absolute value manner, respectively. The cumulative manner refers to determining the local closed-loop power adjustment amount according to both the TPC command sent by the parent node and a historical value of the local closed-loop power adjustment amount of the first node. The absolute value manner refers to updating the local closed-loop power adjustment amount directly according to the TPC command sent by the parent node.

If the power headroom is calculated based on an actual transmission, the power headroom is the maximum transmit power of the first node or the MT of the first node minus a transmit power required for the actual uplink transmission, or the power headroom is the maximum transmit power included in the second power control assistance information minus a transmit power required for the actual uplink transmission. The transmit power required for the actual uplink transmission is related to at least one of the following parameters: a target received power of a transmission, a bandwidth occupied by a transmission, a subcarrier spacing used by a transmission, a frequency domain location occupied by a transmission, a modulation and coding scheme (MCS) of a transmission, a data rate of a transmission, a type of data included in a transmission (for example, the data type includes at least one of: uplink shared channel data, channel state information, or uplink control information), a path loss factor of a transmission, a path loss of a transmission, a local closed-loop power control adjustment amount (which is determined, for example, according to a received TPC command), a transmission channel type, or a format for an uplink control channel transmission.

If the power headroom is calculated based on a reference format, the power headroom is the maximum transmit power of the first node or the MT of the first node minus a transmit power determined through a reference power control parameter, or the power headroom is the maximum transmit power included in the second power control assistance information minus a transmit power determined through a reference power control parameter. The transmit power determined through the reference power control parameter is related to at least one of the following parameters: a target received power of a transmission, a path loss factor of a transmission, a path loss of a transmission, a local closed-loop power control adjustment amount, or a transmission channel type.

For example, for a physical uplink shared channel (PUSCH) transmission occasion i on an activated uplink BWP b of a carrier f of a serving cell c, the formula for Type 1 power headroom (PH) calculated based on the actual transmission is as follows:

$${PH}_{type 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {▯}_{TF , b , f , c} ( i ) + {f}_{b , f , c} ( i , l ) \} ,$$

where, i is the PUSCH transmission occasion, j is an index of a set of open-loop power control parameters for a PUSCH transmission, q_{d} is an index of a reference signal used for path loss measurement, l is a number of closed-loop power control (that is, a number of the power control process), P_{CMAX,f,c}(i) is the maximum transmit power of the first node or the MT of the first node, P_{O_PUSCH,b,f,c}(j) is a target received power of a PUSCH, M_{RB,b,f,c}^{PUSCH}(i) is a bandwidth (expressed as the number of resource blocks (RBs)) assigned to a PUSCH transmission, μ is a subcarrier spacing configuration, α_{b,f,c}(j) is a path loss compensation factor, PL_{b,f,c}(q_{d}) is a path loss, Δ_{TF,b,f,c} is a power offset related to an MCS, and f_{b,f,c}(i,l) is a local closed-loop power adjustment amount.

For another example, for a PUSCH transmission occasion i on an activated uplink BWP b of a carrier f of a serving cell c, the formula for Type 1 PH calculated based on the reference format is as follows:

$${PH}_{type 1 , b , f , c ( i , j , {q}_{d} , l )} = {\tilde{P}}_{CMAX , f , c} ( i ) - \{ {P}_{O \_ PUSCH , b , f , c} ( j ) + {α}_{b , f , c} ( j ) \cdot {PL}_{b , f , c} ( {q}_{d} ) + {f}_{b , f , c} ( i , l ) \} ,$$

where, \tilde{P}_{CMAX,f,c}(i) is calculated assuming maximum power reduction (MPR)=0 dB, A-MPR=0 dB, P-MPR=0 dB and T_{C}=0 dB, and the values of j, q_{d} and/in the formula for Type 1 PH calculated based on the reference format are predefined, for example, each is the first of multiple configured values, that is, the value is zero. The meanings of the parameters are the same as those in the formula for Type 1 PH calculated based on the actual transmission.

The formulas for calculating PH of other types and the meanings of the parameters in the formulas can be found in Technical Specification 38.213 (TS38.213), TS38.101 and TS38.174, and the details will not be repeated here.

In an embodiment, the expected power adjustment amount is an adjustment amount relative to one of the following:
a received TPC command; a transmit power of a most recent uplink transmission prior to an uplink transmission carrying the expected power adjustment amount; a transmit power of an uplink transmission carrying the expected power adjustment amount; a transmit power of an uplink reference signal, where the uplink reference signal is indicated by the first node; a transmit power corresponding to an uplink reference signal set, where the uplink reference signal set is indicated by the first node; or a transmit power of an uplink transmission on a time domain resource, where the time domain resource is indicated by the first node. For example, the first node indicates a time domain resource by indicating a slot index, a subframe index or a time domain resource identifier.

The channel type of the uplink transmission carrying the expected power adjustment amount may be the same as or different from the channel type of the most recent uplink transmission. For example, the channel type of the uplink transmission carrying the expected power adjustment amount is an uplink traffic channel PUSCH, and the channel type of the most recent uplink transmission may be a most recent uplink traffic channel PUSCH or a most recent uplink control channel physical uplink control channel (PUCCH).

In an embodiment, the expected power adjustment amount is an adjustment amount relative to the received TPC command, and the TPC command satisfies at least one of the following conditions:
a power control process corresponding to the TPC command is the same as a power control process corresponding to the expected power adjustment amount; a transmission type corresponding to the TPC command is the same as a transmission type corresponding to the expected power adjustment amount; a multiplexing manner corresponding to the TPC command is the same as a multiplexing manner corresponding to the expected power adjustment amount; an uplink transmission timing corresponding to the TPC command is the same as an uplink transmission timing corresponding to the expected power adjustment amount; the TPC command is a TPC command transmitted on a time domain resource corresponding to the expected power adjustment amount; the TPC command is a TPC command transmitted on a time domain resource occupied for transmitting the expected power adjustment amount; or a timing mode corresponding to the TPC command is the same as a timing mode corresponding to the expected power adjustment amount.

In an embodiment, the expected power adjustment amount is an adjustment amount relative to the transmit power of the most recent uplink transmission prior to the uplink transmission carrying the expected power adjustment amount or an adjustment amount relative to the transmit power of the uplink transmission carrying the expected power adjustment amount, and the uplink transmission satisfies at least one of the following conditions:
a power control process corresponding to the uplink transmission is the same as a power control process corresponding to the expected power adjustment amount; a transmission type corresponding to the uplink transmission is the same as a transmission type corresponding to the expected power adjustment amount; a multiplexing manner corresponding to the uplink transmission is the same as a multiplexing manner corresponding to the expected power adjustment amount; an uplink transmission timing corresponding to the uplink transmission is the same as an uplink transmission timing corresponding to the expected power adjustment amount; the uplink transmission is an uplink transmission transmitted on a time domain resource corresponding to the expected power adjustment amount; the uplink transmission is an uplink transmission transmitted on a time domain resource occupied for transmitting the expected power adjustment amount; or a timing mode corresponding to the uplink transmission is the same as a timing mode corresponding to the expected power adjustment amount.

In an embodiment, the second power control assistance information is carried by one or more of: a radio resource control (RRC) signaling, a physical uplink control channel, a media access control-control element (MAC-CE), or an F1 application protocol (F1AP).

In an embodiment, the first power control assistance information is carried by one or more of: an RRC signaling, a physical uplink control channel, an MAC-CE, or an F1AP.

In an embodiment, different parameters in the first power control assistance information may be carried using different carrying manners. For example, the expected power adjustment amount is carried through the MAC-CE, and the remaining parameters in the first power control assistance information are carried through the RRC signaling. For another example, the expected power adjustment amount and the power control process are carried through the MAC-CE, and the remaining parameters in the first power control assistance information are carried through the RRC signaling.

In an embodiment, the information transmission method includes one of:
one multiplexing manner corresponds to one piece of power control assistance information; one multiplexing manner and one uplink transmission type correspond to one piece of power control assistance information; one uplink transmission timing corresponds to one piece of power control assistance information; one uplink transmission timing and one uplink transmission type correspond to one piece of power control assistance information; one time domain resource corresponds to one piece of power control assistance information; one time domain resource and one uplink transmission type correspond to one piece of power control assistance information; one timing mode corresponds to one piece of power control assistance information; or one timing mode and one uplink transmission type correspond to one piece of power control assistance information.

The power control assistance information includes the first power control assistance information and/or the second power control assistance information. One piece of power control assistance information may be considered as one piece of first power control assistance information, one piece of power control assistance information may be considered as one piece of second power control assistance information, or one piece of power control assistance information may also be considered as one piece of first power control assistance information and one piece of second power control assistance information.

In an embodiment, the multiplexing manner includes at least one of: a multiplexing manner between the MT and the DU of the first node or a multiplexing manner between the MT and the DU of the parent node of the first node.

In an embodiment, the uplink transmission type refers to an uplink transmission type of the MT of the first node.

In an embodiment, the multiplexing manner includes at least one of the schemes described below.

Scheme A: MT transmission and DU transmission of the first node work simultaneously; Scheme B: MT reception and DU reception of the first node work simultaneously; Scheme C: MT reception and DU transmission of the first node work simultaneously; Scheme D: MT transmission and DU reception of the first node work simultaneously; Scheme E: MT and DU of the first node work in time-division multiplexing (TDM), that is, the resources used by the MT and the resources used by the DU in the node are orthogonal in time; Scheme F: MT reception and DU reception of the parent node work simultaneously.

In an embodiment, one multiplexing manner corresponds to one piece of power control assistance information. For example, the scheme A corresponds to one piece of power control assistance information, and other multiplexing manners (which may be any multiplexing manner other than the scheme A and are not limited to schemes B, C, D, E, and F) correspond to one piece of power control assistance information. For another example, the scheme A corresponds to one piece of power control assistance information, the scheme D corresponds to one piece of power control assistance information, and the scheme E corresponds to one piece of power control assistance information.

In an embodiment, one multiplexing manner and one uplink transmission type correspond to one piece of power control assistance information. In an embodiment, for the multiplexing manner scheme A, a PUSCH, a PUCCH and a sounding reference signal (SRS) correspond to one piece of power control assistance information, respectively, and for other multiplexing manners, a PUSCH, a PUCCH and an SRS correspond to one piece of power control assistance information, respectively. For another example, for the multiplexing manner scheme A, a dynamically scheduled uplink transmission and a semi-statically scheduled uplink transmission correspond to one piece of power control assistance information, respectively, and for other multiplexing manners, a dynamically scheduled uplink transmission and a semi-statically scheduled uplink transmission correspond to one piece of power control assistance information, respectively.

In an embodiment, the transmission timing may refer to an uplink transmission timing of the MT of the first node (referred to as the uplink transmission timing of the first node).

In an embodiment, the uplink transmission timing of the first node includes at least one of the transmission timings described below.

Transmission timing 1: the uplink transmission timing of the first node is an uplink transmission timing aligned with a downlink transmission timing of the first node or an uplink transmission timing corresponding to a case where the first node adopts the multiplexing manner scheme A; Transmission timing 2: the uplink transmission timing of the first node is an uplink transmission timing aligned with an uplink reception timing of the first node or an uplink transmission timing corresponding to a case where the first node adopts the multiplexing manner scheme D; Transmission timing 3: the uplink transmission timing of the first node is an ordinary uplink transmission timing, an uplink transmission timing corresponding to a case where the first node adopts the multiplexing manner scheme E or an uplink transmission timing determined in a manner where an ordinary terminal determines an uplink transmission timing; Transmission timing 4: the uplink transmission timing of the first node is an uplink transmission timing corresponding to a case where the first node adopts the multiplexing manner scheme F.

In an embodiment, one uplink transmission timing corresponds to one piece of power control assistance information. For example, the transmission timing 1 corresponds to one piece of power control assistance information, and other transmission timings (which may be any uplink transmission timing other than the transmission timing 1 and are not limited to transmission timings 2, 3, and 4) correspond to one piece of power control assistance information. For another example, the transmission timing 1, the transmission timing 3 and the transmission timing 4 correspond to one piece of power control assistance information, respectively.

In an embodiment, one uplink transmission timing and one uplink transmission type correspond to one piece of power control assistance information. For example, for the transmission timing 1, a PUSCH, a PUCCH and an SRS correspond to one piece of power control assistance information, respectively, and for other transmission timings, a PUSCH, a PUCCH and an SRS correspond to one piece of power control assistance information, respectively.

In an embodiment, the uplink transmission timing of the first node refers to an uplink transmission timing of the MT of the first node.

In an embodiment, the downlink reception timing of the first node refers to a downlink reception timing of the MT of the first node.

In an embodiment, the uplink reception timing of the first node refers to an uplink reception timing of the DU of the first node.

In an embodiment, the downlink transmission timing of the first node refers to a downlink transmission timing of the DU of the first node.

In an embodiment, the time domain resource refers to a time domain resource on the backhaul link of the first node, that is, a time domain resource for data transmission between the MT of the first node and its serving cell (for example, the DU of the parent node or the CU).

In an embodiment, one time domain resource corresponds to one piece of power control assistance information. For example, the time domain resource 1 corresponds to one piece of power control assistance information, and other time domain resources (any time domain resource other than the time domain resource 1) correspond to one piece of power control assistance information. The time domain resource may be configured by a network side, may be determined according to the multiplexing manner of the first node, may be determined according to the uplink transmission timing of the first node, or may be determined according to the uplink transmission type of the first node. 1 in the time domain resource 1 is only used for distinguishing time domain resources.

In an embodiment, one time domain resource and one uplink transmission type correspond to one piece of power control assistance information. For example, for the time domain resource 1, a PUSCH, a PUCCH and an SRS correspond to one piece of power control assistance information, respectively, and for other time domain resources, a PUSCH, a PUCCH and an SRS correspond to one piece of power control assistance information, respectively.

In an embodiment, a timing of a node includes at least one of: an uplink transmission timing of an MT of the node (referred to as the uplink transmission timing of the node), a downlink reception timing of an MT of the node (referred to as the downlink reception timing of the node), an uplink reception timing of a DU of the node (referred to as the uplink reception timing of the node), or a downlink transmission timing of a DU of the node (referred to as the downlink transmission timing of the node).

The timing mode includes at least one of: an alignment relationship between a timing of the MT of the first node and a timing of the DU of the first node or an alignment relationship between a timing of the MT of the parent node of the first node and a timing of the DU of the parent node of the first node.

In an embodiment, the timing mode includes at least one of the timing modes described below.

Timing mode 1: an uplink transmission timing of the first node is aligned with a downlink transmission timing of the first node; Timing mode 2: an uplink transmission timing of the first node is aligned with an uplink reception timing of the first node; Timing mode 3: a downlink reception timing of the parent node is aligned with an uplink reception timing of the parent node; Timing mode 4: a downlink transmission timing of the first node is aligned with a downlink transmission timing of the parent node; Timing mode 5: a downlink reception timing of the first node is aligned with a downlink transmission timing of the first node; Timing mode 6: a downlink reception timing of the first node is aligned with an uplink reception timing of the first node.

The parent node is the parent node of the first node. The timing mode is not limited here.

In an embodiment, one timing mode corresponds to one piece of power control assistance information. For example, the timing mode 1 corresponds to one piece of power control assistance information, and other timing modes (any timing mode other than the timing mode 1) correspond to one piece of power control assistance information. For another example, the timing mode 1, the timing mode 2 and the timing mode 3 correspond to one piece of power control assistance information, respectively.

In an embodiment, one timing mode and one uplink transmission type correspond to one piece of power control assistance information. For example, for the timing mode 1, a PUSCH, a PUCCH and an SRS correspond to one piece of power control assistance information, respectively, and for other timing modes, a PUSCH, a PUCCH and an SRS correspond to one piece of power control assistance information, respectively.

In an embodiment, the uplink transmission type includes one or more of:
a PUSCH transmission, a PUCCH transmission, an SRS transmission, a dynamically scheduled transmission, or a semi-statically scheduled transmission.

In an embodiment, the dynamically scheduled transmission refers to an uplink transmission scheduled by a downlink control channel.

In an embodiment, the semi-statically scheduled transmission includes at least one of:
an uplink transmission configured by an RRC signaling, an uplink transmission configured by an RRC signaling and activated by a downlink control channel, or an uplink transmission configured by an RRC signaling and activated by an MAC-CE.

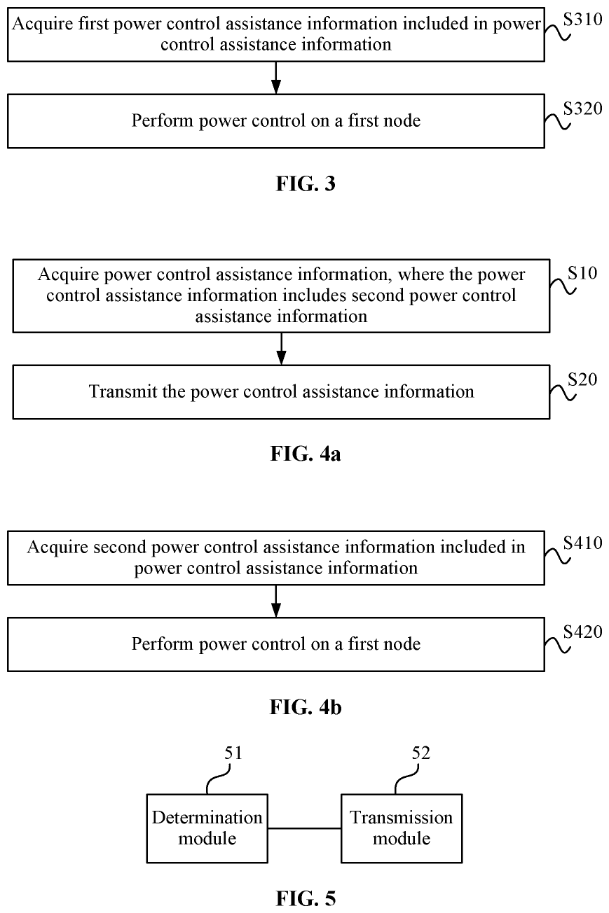

In an example implementation, the present application further provides an information transmission method. FIG. 3 is a flowchart of another information transmission method according to an embodiment of the present application. The method is suitable for the case of performing power control on a first node. The method may be executed by an information transmission apparatus. The apparatus may be implemented by software and/or hardware and integrated into a second node. The second node may be a parent node of the first node or a CU.

As shown in FIG. 3, the information transmission method provided by the present application includes S310 and S320.

In S310, first power control assistance information included in power control assistance information is acquired.

The first power control assistance information transmitted by the first node or a third node may be acquired. The third node is not limited here. In a case where the second node is a parent node of the first node, the third node may be a CU, and in the case where the second node is a CU, the third node may be a parent node of the first node.

The second node may acquire the first power control assistance information of the first node, and the first power control assistance information is transmitted by the first node to the second node. Alternatively, the first node transmits the first power control assistance information of the first node to the third node, and the third node may transmit the acquired first power control assistance information to the second node.

In S320, power control is performed on the first node.

In a case where the second node is a CU, semi-static power control is performed on the first node, for example, a power control parameter is configured for the first node through an RRC signaling. In a case where the second node is a parent node of the first node, semi-static or dynamic power control is performed on the first node, for example, at least one set of power control parameters is configured for the first node through an RRC signaling, one set of power control parameters is indicated through a downlink control channel, and the second node may also transmit a TPC command through the downlink control channel.

In an embodiment, both the parent node of the first node and the CU can perform power control on the first node.

In the information transmission method provided in this embodiment of the present application, first power control assistance information included in power control assistance information is first acquired, and then power control is performed on the first node. Through this method, the power control is effectively performed on the first node. For the content that is not yet exhaustive in this embodiment, reference may be made to the preceding embodiments, and the details are not repeated here.

Based on the preceding embodiment, variant embodiments of the preceding embodiment are provided. For the brevity of description, only differences from the preceding embodiment are described in the variant embodiments.

In an embodiment, the first power control assistance information is transmitted to the third node.

The third node acquires the first power control assistance information and then can perform power control on the first node.

In an embodiment, the first power control assistance information is acquired from the first node or the third node.

In an embodiment, the third node acquires the first power control assistance information from the first node.

In an embodiment, the method further includes the following.

Second power control assistance information is acquired.

In an embodiment, the second power control assistance information is acquired from the first node or the third node.

In an embodiment, the third node acquires the second power control assistance information from the first node.

In an embodiment, the method further includes the following.

The second power control assistance information is transmitted to the third node.

The third node acquires the second power control assistance information and then can perform power control on the first node.

In an example implementation, the present application further provides an information transmission method. FIG. 4a is a flowchart of another information transmission method according to an embodiment of the present application. The method is executed by an information transmission apparatus and integrated into a first node. For the content that is not yet exhaustive in this embodiment, reference may be made to other embodiments, and the details are not repeated here.

With reference to FIG. 4a, the method includes S10 and S20.

In S10, power control assistance information is determined, where the power control assistance information includes second power control assistance information.

In S20, the power control assistance information is transmitted.

The second power control assistance information may be transmitted by a first node to a second node, or the second power control assistance information may be transmitted by the first node to a third node and then the third node transmits the second power control assistance information to the second node.

The corresponding content of the second power control assistance information is not described in detail in this embodiment, and for the details, reference may be made to the preceding embodiments.

In the information transmission method provided in this embodiment of the present application, power control assistance information is first determined, where the power control assistance information includes second power control assistance information, and then the power control assistance information is transmitted. Through this method, the power control is effectively performed on the first node.

In an embodiment, the information transmission method includes one of:
one multiplexing manner corresponds to one piece of second power control assistance information;
one multiplexing manner and one uplink transmission type correspond to one piece of second power control assistance information; one uplink transmission timing corresponds to one piece of second power control assistance information; one uplink transmission timing and one uplink transmission type correspond to one piece of second power control assistance information; one time domain resource corresponds to one piece of second power control assistance information; one time domain resource and one uplink transmission type correspond to one piece of second power control assistance information; one timing mode corresponds to one piece of second power control assistance information; or one timing mode and one uplink transmission type correspond to one piece of second power control assistance information.

In an example implementation, the present application further provides an information transmission method. FIG. 4b is a flowchart of yet another information transmission method according to an embodiment of the present application. The method is suitable for the case of performing power control on a first node. The method may be executed by software and/or hardware and integrated into a second node.

As shown in FIG. 4b, the information transmission method provided in this embodiment includes S410 and S420.

In S410, second power control assistance information included in power control assistance information is acquired.

The second node may acquire the second power control assistance information of the first node, and the second power control assistance information is transmitted by the first node to the second node. Alternatively, the first node transmits the second power control assistance information of the first node to the third node, and the third node may transmit the acquired second power control assistance information to the second node.

In an embodiment, the first node transmits the second power control assistance information of the first node to the second node, and the second node may transmit the acquired second power control assistance information to the third node.

In an embodiment, the information transmission method includes one of:
one multiplexing manner corresponds to one piece of second power control assistance information; one multiplexing manner and one uplink transmission type correspond to one piece of second power control assistance information; one uplink transmission timing corresponds to one piece of second power control assistance information; one uplink transmission timing and one uplink transmission type correspond to one piece of second power control assistance information; one time domain resource corresponds to one piece of second power control assistance information; one time domain resource and one uplink transmission type correspond to one piece of second power control assistance information; one timing mode corresponds to one piece of second power control assistance information; or one timing mode and one uplink transmission type correspond to one piece of second power control assistance information.

In S420, power control is performed on the first node.

In the information transmission method provided by the present application, second power control assistance information included in power control assistance information is acquired, and then power control is performed on the first node based on the second power control assistance information. Through this method, the power control is effectively performed on the first node.

The following is an example description of the information transmission method provided by the present application. The information transmission method may be considered as a method of transmitting power control assistance information. In this example, the method is described using an example where the first node is an IAB node.

The IAB node determines power control assistance information; and the IAB node indicates the power control assistance information. The power control assistance information includes first power control assistance information and/or second power control assistance information. The first power control assistance information includes an expected transmit power spectral density. The second power control assistance information includes at least one of: a PH, a maximum transmit power, or headroom calculation indication information.

The expected transmit power spectral density includes one of: an expected transmit power per frequency unit or an expected transmit power range per frequency unit.

The frequency domain unit includes at least one of: an RB, a subcarrier, a frequency unit Hz, an RB group, a subcarrier group, a BWP, a physical channel, a physical signal, or a carrier.

A subcarrier spacing of the frequency domain unit may be indicated by the IAB node (that is, the first node) or may be predefined.

The first power control assistance information further includes at least one of: an expected transmit bandwidth, an expected transmit bandwidth range, an expected maximum transmit power, an expected transmit power, an expected transmit power range, an expected power adjustment amount, a power control process, or a transmit power of a DU of the first node.

The power headroom is a maximum transmit power of the first node minus an estimated power for an uplink transmission, the power headroom is a maximum transmit power of an MT of the first node minus an estimated power for an uplink transmission, or the power headroom is a maximum transmit power included in the second power control assistance information minus an estimated power for an uplink transmission.

The maximum transmit power of the first node is defined or specified in the protocol.

The maximum transmit power of the MT of the first node is defined or specified in the protocol.

The maximum transmit power included in the second power control assistance information is used for calculating a maximum transmit power of the power headroom.

The headroom calculation indication information is used for indicating whether the PH is calculated based on an actual transmission or based on a reference format. For example, when the value of the indication information is 0, the indication information indicates that the PH is calculated based on an actual transmission, and when the value of the indication information is 1, the indication information indicates that the PH is calculated based on a reference format.

Depending on the transmission type considered in the calculation of the power headroom, the PH may be differentiated into different types. For example, a Type 1 PH is for a PUSCH transmission, a Type 2 PH is for a PUCCH transmission or PUSCH+PUCCH transmissions, and a Type 3 PH is for an SRS transmission.

One transmission type or one PH type corresponds to one piece of headroom calculation indication information. For example, the PH indication information corresponding to the Type 1 PH (or a PUSCH) is used for indicating whether the PH value is calculated based on an actual PUSCH transmission or based on a PUSCH reference format, the PH indication information corresponding to the Type 2 PH (a PUCCH, or PUSCH+PUCCH) is used for indicating whether the PH value is calculated based on an actual PUCCH transmission or based on a PUCCH reference format, and the PH indication information corresponding to the Type 3 PH (or an SRS) is used for indicating whether the PH value is calculated based on an actual SRS transmission or based on an SRS reference format.

The expected power adjustment amount is an adjustment amount relative to one of:
a TPC command received by the IAB node; a transmit power of a most recent uplink transmission prior to an uplink transmission carrying the expected power adjustment amount, where the uplink transmission is at least one of: an uplink transmission in a multiplexing manner corresponding to the expected power adjustment amount, an uplink transmission in a timing mode corresponding to the expected power adjustment amount, an uplink transmission in an uplink transmission timing corresponding to the expected power adjustment amount, an uplink transmission on a time domain resource corresponding to the expected power adjustment amount, or an uplink transmission on a time domain resource occupied for transmitting the expected power adjustment amount, that is, at least one of the multiplexing manner, the timing mode or the time domain resource corresponding to the uplink transmission is the same as at least one respective of the multiplexing manner, the timing mode or the time domain resource corresponding to the expected power adjustment amount; a transmit power of an uplink transmission carrying the expected power adjustment amount; a transmit power or received power of a specific uplink reference signal (an uplink reference signal indicated by the first node), where for example, the first node indicates a corresponding uplink reference signal index to indicate the specific uplink reference signal; a transmit power corresponding to a specific set of uplink reference signals (a set of uplink reference signals indicated by said first node), where for example, the first node indicates an index of a corresponding set of uplink reference signals to indicate the specific set of uplink reference signals; or a transmit power or received power of an uplink transmission on a specific time domain resource (a time domain resource indicated by the first node), where for example, the first node indicates a corresponding slot to indicate the specific time domain resource or indicates an offset relative to a slot in which a resource carrying the expected power adjustment amount is located.

The IAB-MT (or simply referred to as the MT) and the IAB-DU (or simply referred to as the DU) in the present application are the MT and the DU of the IAB node, respectively, and the parent node is the parent of the IAB node, that is, the IAB node is a child of the parent node.

The operation where the IAB node indicates the power control assistance information includes: the IAB-MT indicates the power control assistance information for different multiplexing manners, respectively.

The multiplexing manner includes a multiplexing manner between the IAB-MT and the IAB-DU and/or a multiplexing manner between the MT and the DU of the parent node of the IAB node.

For example, the operation where the IAB-MT indicates the power control assistance information includes at least one of: the IAB-MT indicates the power control assistance information corresponding to the case where the IAB-MT and the IAB-DU adopt time-division multiplexing, the IAB-MT indicates the power control assistance information corresponding to the case where the IAB-MT transmission and the IAB-DU transmission work simultaneously, or the IAB-MT indicates the power control assistance information corresponding to the case where the IAB-MT transmission and the IAB-DU reception work simultaneously. Alternatively, the operation where the IAB-MT indicates the power control assistance information includes at least one of: the IAB-MT indicates the power control assistance information corresponding to the case where the IAB-MT transmission and the IAB-DU transmission work simultaneously, or the IAB-MT indicates the power control assistance information corresponding to the case where the IAB-MT and the IAB-DU adopt a multiplexing manner other than the manner in which the IAB-MT transmission and the IAB-DU transmission work simultaneously.

The operation where the IAB node indicates the power control assistance information includes: the IAB-MT indicates the power control assistance information according to different multiplexing manners between the IAB-MT and the IAB-DU and uplink transmission types, respectively.

One combination of a multiplexing manner and an uplink transmission type indicates one piece of power control assistance information.

For example, for the case where the IAB-MT transmission and the IAB-DU transmission work simultaneously, the power control assistance information corresponding to the case where the uplink transmission type is a PUSCH, a PUCCH and an SRS respectively is indicated; for the case where the IAB-MT and the IAB-DU adopt a multiplexing manner other than the manner in which the IAB-MT transmission and the IAB-DU transmission work simultaneously, the power control assistance information corresponding to the case where the uplink transmission type is a PUSCH, a PUCCH and an SRS respectively is indicated.

The operation where the IAB node indicates the power control assistance information includes: the IAB-MT indicates the power control assistance information according to different uplink transmission timings of the IAB-MT, respectively.

For example, the operation where the IAB-MT indicates the power control assistance information includes at least one of: the IAB-MT indicates the power control assistance information corresponding to a case where the IAB-MT adopts an ordinary uplink transmission timing, the IAB-MT indicates the power control assistance information corresponding to a case where the IAB-MT adopts an uplink transmission timing aligned with a downlink transmission timing of the IAB-DU, or the IAB-MT indicates the power control assistance information corresponding to a case where the IAB-MT adopts other uplink transmission timings. The other uplink transmission timings include uplink transmission timings other than the ordinary uplink transmission timing and the uplink transmission timing aligned with the downlink transmission timing of the IAB-DU, for example, an uplink transmission timing of the IAB-MT corresponding to the simultaneous reception of the MT and the DU of the parent node. Alternatively, the operation where the IAB-MT indicates the power control assistance information includes at least one of: the IAB-MT indicates the power control assistance information corresponding to a case where the IAB-MT adopts an uplink transmission timing aligned with a downlink transmission timing of the IAB-DU, or the IAB-MT indicates the power control assistance information corresponding to a case where the IAB-MT adopts an uplink transmission timing other than the uplink transmission timing aligned with the downlink transmission timing of the IAB-DU.

The operation where the IAB node indicates the power control assistance information includes: the IAB-MT indicates the power control assistance information according to different uplink transmission timings of the IAB-MT and uplink transmission types, respectively.

One combination of an uplink transmission timing of the IAB-MT and an uplink transmission type indicates one piece of power control assistance information.

For example, for the case where the IAB-MT adopts the uplink transmission timing aligned with the downlink transmission timing of the IAB-DU, the power control assistance information corresponding to the case where the uplink transmission type is a PUSCH, a PUCCH and an SRS respectively is indicated; for the case where the IAB-MT adopts an uplink transmission timing other than the uplink transmission timing aligned with the downlink transmission timing of the IAB-DU, the power control assistance information corresponding to the case where the uplink transmission type is a PUSCH, a PUCCH and an SRS respectively is indicated.

The operation where the IAB node indicates the power control assistance information includes: the IAB-MT indicates the power control assistance information according to different time domain resources, respectively. The time domain resource is determined in one of the following manners: the time domain resource is configured by a network side, the time domain resource is determined according to a multiplexing manner between the IAB-MT and the IAB-DU, or the time domain resource is determined according to an uplink transmission timing of the IAB-MT.

For example, when the time domain resource is determined according to the multiplexing manner between the IAB-MT and the IAB-DU, the operation where the IAB-MT indicates the power control assistance information includes at least one of: the IAB-MT indicates the power control assistance information corresponding to a time domain resource in a case where the IAB-MT and the IAB-DU adopt time-division multiplexing, the IAB-MT indicates the power control assistance information corresponding to a time domain resource in a case where the IAB-MT transmission and the IAB-DU transmission work simultaneously, or the IAB-MT indicates the power control assistance information corresponding to a time domain resource in a case where the IAB-MT transmission and the IAB-DU reception work simultaneously. Alternatively, the operation where the IAB-MT indicates the power control assistance information includes at least one of: the IAB-MT indicates the power control assistance information corresponding to a time domain resource in a case where the IAB-MT transmission and the IAB-DU transmission work simultaneously, or the IAB-MT indicates the power control assistance information corresponding to a time domain resource in a case where the IAB-MT and the IAB-DU adopt a multiplexing manner other than the manner in which the IAB-MT transmission and the IAB-DU transmission work simultaneously.

The operation where the IAB node indicates the power control assistance information includes: the IAB-MT indicates the power control assistance information according to different time domain resources and uplink transmission types, respectively.

One combination of a time domain resource and an uplink transmission type indicates one piece of power control assistance information.

For example, for the case where the IAB-MT transmission and the IAB-DU transmission work simultaneously, the power control assistance information corresponding to the case where the uplink transmission type is a PUSCH, a PUCCH and an SRS respectively is indicated; for the case where the IAB-MT and the IAB-DU adopt a multiplexing manner other than the manner in which the IAB-MT transmission and the IAB-DU transmission work simultaneously, the power control assistance information corresponding to the case where the uplink transmission type is a PUSCH, a PUCCH and an SRS respectively is indicated.

The operation where the IAB node indicates the power control assistance information includes: the IAB-MT indicates the power control assistance information according to different timing modes, respectively.

One timing mode indicates one piece of power control assistance information.

The timing mode is configured by the network side for the IAB node, the timing mode is determined according to a transmission direction between the IAB-MT and the IAB-DU, the timing mode is determined according to a multiplexing manner between the IAB-MT and the IAB-DU, or the timing mode is determined according to an uplink transmission timing of the IAB-MT.

The operation where the IAB node indicates the power control assistance information includes: the IAB-MT indicates the power control assistance information according to different timing modes and uplink transmission types, respectively.

One combination of a timing mode and an uplink transmission type indicates one piece of power control assistance information.

The uplink transmission type includes at least one of: a PUSCH transmission, a PUCCH transmission, an SRS transmission, a dynamically scheduled transmission, or a semi-statically scheduled transmission.

When the IAB node indicates the first power control assistance information, The IAB-MT transmits the first power control assistance information to the parent node; the IAB-MT transmits the first power control assistance information to the CU and the parent node, respectively; the IAB-MT transmits the first power control assistance information to the CU, and the CU transmits the first power control assistance information to the parent node; or the IAB-MT transmits the first power control assistance information to the parent node, and the parent node transmits the first power control assistance information to the CU.

The operation where the IAB node indicates the second power control assistance information includes: the IAB-MT transmits the second power control assistance information to the parent node.

For the transmission method of the second power control assistance information, reference may be made to the transmission method of the first power control assistance information, and the details are not repeated here.

The first power control assistance information may be carried in at least one of the following manners.

The IAB-MT transmits the first power control assistance information to the parent node through an RRC signaling, a PUCCH or an MAC-CE; the IAB-MT transmits the first power control assistance information to the CU through an F1AP or an RRC signaling; the CU transmits the first power control assistance information to the parent node through an F1AP or an RRC signaling; or the parent node transmits the first power control assistance information to the CU through an F1AP or an RRC signaling.

The parent node is the parent node of the IAB node.

The second power control assistance information may be carried through at least one of: an RRC signaling, a PUCCH, or an MAC-CE.

Different parameters in the first power control assistance information may be carried using the same carrying manner or different carrying manners.

For example, the expected power adjustment amount may be carried through an MAC-CE or a PUCCH, and other parameters in the first power control assistance information other than the expected power adjustment amount are carried through an RRC signaling or an F1AP. For another example, the expected power adjustment amount and the power control process may be carried through an MAC-CE or a PUCCH, and other parameters in the first power control assistance information other than the expected power adjustment amount and the power control process are carried through an RRC signaling or an F1AP.

Different parameters in the second power control assistance information may be carried using the same carrying manner or different carrying manners.

The network side in the present application refers to the CU and/or the parent node of the IAB node, or refers to a serving cell of the MT of the IAB node.

Only preferred examples of the first power control assistance information and the second power control assistance information are given below, and the scope of the present application is not limited thereto. The network side may know information such as the expected power spectral density, the expected transmit power and the current power headroom of the IAB-MT according to the power control assistance information and thus reasonably control the transmit power of the IAB-MT.

### Example 1

The first power control assistance information includes one of:

1) an expected transmit power per frequency unit and an expected transmit bandwidth; 2) an expected transmit power range per frequency unit and an expected transmit bandwidth; 3) an expected transmit power per frequency unit and an expected transmit bandwidth range; 4) an expected transmit power per frequency unit and an expected maximum transmit power; 5) an expected transmit power range per frequency unit and an expected maximum transmit power; 6) an expected transmit power per frequency unit and an expected transmit power; 7) an expected transmit power range per frequency unit and an expected transmit power; 8) an expected transmit power per frequency unit and an expected power range; 9) an expected transmit power per frequency unit and an expected power adjustment amount; 10) an expected transmit power range per frequency unit and an expected power adjustment amount; 11) an expected transmit power per frequency unit, an expected power adjustment amount, and a power control process; 12) an expected transmit power range per frequency unit, an expected power adjustment amount, and a power control process; 13) an expected transmit power per frequency unit and a transmit power of the DU of the IAB node; 14) an expected transmit power range per frequency unit and a transmit power of the DU of the IAB node; 15) an expected transmit power per frequency unit; or 16) an expected transmit power range per frequency unit.

### Example 2

The second power control assistance information includes one of:
a power headroom; a maximum transmit power; a power headroom and headroom calculation indication information; or a power headroom, a maximum transmit power and headroom calculation indication information.

Unless otherwise specified, in all descriptions in the present application, the frequency domain range is for a component carrier (CC), a cell, a BWP or a transmit beam, and all of the parameters in the present application can be extended to multiple CCs, multiple cells, multiple BWPs or multiple transmit beams simply by separately providing the relevant parameters for each CC, each cell, each BWP or each transmit beam.

Unless otherwise specified, the uplink transmission in the present application is the uplink transmission of the MT of the first node. For example, the uplink transmission includes the transmission of uplink channels and signals such as a PUSCH, a PUCCH and an SRS.

The IAB-MT may be the MT of the IAB node, or may be other devices or functional units, such as a relay node, a terminal functional unit of a relay node, a transmit-receive point (TRP), and an access point (AP). The IAB-DU may be the DU of the IAB node, or may be other devices or functional units, such as a relay node, a base-station functional unit of a relay node, a transmit-receive point (TRP), and an access point (AP).

For the information transmission method or apparatus integrated into the first node, in the preceding embodiments, “one x corresponds to one y” means that the first node transmits one y for one x. “One x and one uplink transmission type correspond to one y” means that the first node transmits one y for one combination of an x and an uplink transmission type. Different y may be transmitted using the same packet or may be transmitted using different packets.

For the information transmission method or apparatus integrated into the second node, in the preceding embodiments, “one x corresponds to one y” means that the second node acquires one y for one x. “One x and one uplink transmission type correspond to one y” means that the second node acquires one y for one combination of an x and an uplink transmission type. Different y may be acquired from the same packet or may be acquired from different packets.

The x represents one of: a multiplexing manner, an uplink transmission timing, a time domain resource, or a timing mode. The y represents at least one of: the first power control assistance information or the second power control assistance information.

The present application provides an information transmission apparatus. FIG. 5 is a structure diagram of an information transmission apparatus according to an embodiment of the present application. The apparatus may be configured in a first node. For the content that is not yet exhaustive in this embodiment, reference may be made to the preceding embodiments, and the details are not repeated here. As shown in FIG. 5, the apparatus includes a determination module 51 and a transmission module 52.

The determination module 51 is configured to determine power control assistance information, and the transmission module 52 is configured to transmit the power control assistance information; where the power control assistance information includes first power control assistance information, and the first power control assistance information indicates an expected transmit power spectral density.

The information transmission apparatus provided in this embodiment is configured to implement the information transmission method in the embodiment shown in FIG. 1. The implementation principles and effects of the information transmission apparatus provided in this embodiment are similar to those of the information transmission method in the embodiment shown in FIG. 1, and the details are not repeated here.

Based on the preceding embodiment, variant embodiments of the preceding embodiment are provided. For the brevity of description, only differences from the preceding embodiment are described in the variant embodiments.

In an embodiment, the expected transmit power spectral density includes one or more of: an expected transmit power per frequency unit or an expected transmit power range per frequency unit.

In an embodiment, a subcarrier spacing corresponding to the frequency unit is indicated by the first node or predefined.

In an embodiment, the frequency unit includes one or more of: an RB, a subcarrier, a frequency unit Hz, an RB group, a subcarrier group, a BWP, a physical channel, a physical signal, or a carrier.

In an embodiment, the power control assistance information further includes second power control assistance information, and the second power control assistance information includes one or more of:
a power headroom, a maximum transmit power, or headroom calculation indication information.

In an embodiment, the power headroom is a maximum transmit power of the first node minus an estimated power for an uplink transmission, the power headroom is a maximum transmit power of an MT of the first node minus an estimated power for an uplink transmission, or the power headroom is the maximum transmit power included in the second power control assistance information minus an estimated power for an uplink transmission.

In an embodiment, the maximum transmit power of the first node is defined or specified in the protocol.

In an embodiment, the maximum transmit power of the MT of the first node is defined or specified in the protocol.

In an embodiment, the maximum transmit power included in the second power control assistance information is used for calculating the power headroom included in the second power control assistance information.

In an embodiment, the headroom calculation indication information is used for indicating a calculation manner of the power headroom included in the second power control assistance information, and the calculation manner includes calculating based on an actual transmission and calculating based on a reference format.

In an embodiment, the first power control assistance information further includes one or more of:
an expected transmit bandwidth, an expected transmit bandwidth range, an expected maximum transmit power, an expected transmit power, an expected transmit power range, an expected power adjustment amount, a power control process, or a transmit power of a DU of the first node.

In an embodiment, the expected power adjustment amount is an adjustment amount relative to one of the following:
a received TPC command; a transmit power of a most recent uplink transmission prior to an uplink transmission carrying the expected power adjustment amount; a transmit power of an uplink transmission carrying the expected power adjustment amount; a transmit power of an uplink reference signal, where the uplink reference signal is indicated by the first node; a transmit power corresponding to an uplink reference signal set, where the uplink reference signal set is indicated by the first node; or a transmit power of an uplink transmission on a time domain resource, where the time domain resource is indicated by the first node.

In an embodiment, the second power control assistance information is carried by one or more of: an RRC signaling, a physical uplink control channel, an MAC-CE, or an F1AP.)

In an embodiment, the first power control assistance information is carried by one or more of: an RRC signaling, a physical uplink control channel, an MAC-CE, or an F1AP.

In an embodiment, different parameters in the first power control assistance information may be carried using different carrying manners.

In an embodiment, the apparatus includes one of:
one multiplexing manner corresponds to one piece of power control assistance information; one multiplexing manner and one uplink transmission type correspond to one piece of power control assistance information; one uplink transmission timing corresponds to one piece of power control assistance information; one uplink transmission timing and one uplink transmission type correspond to one piece of power control assistance information; one time domain resource corresponds to one piece of power control assistance information; one time domain resource and one uplink transmission type correspond to one piece of power control assistance information; one timing mode corresponds to one piece of power control assistance information; or one timing mode and one uplink transmission type correspond to one piece of power control assistance information.

The power control assistance information includes the first power control assistance information and/or the second power control assistance information. One piece of power control assistance information may be considered as one piece of first power control assistance information, one piece of power control assistance information may be considered as one piece of second power control assistance information, or one piece of power control assistance information may also be considered as one piece of first power control assistance information and one piece of second power control assistance information.

In an embodiment, the uplink transmission type includes one or more of:
a PUSCH transmission, a PUCCH transmission, an SRS transmission, a dynamically scheduled transmission, or a semi-statically scheduled transmission.

In an example implementation, an embodiment of the present application provides an information transmission apparatus. FIG. 6 is a structure diagram of another information transmission apparatus according to an embodiment of the present application. The apparatus may be configured in a second node. For the content that is not yet exhaustive in this embodiment, reference may be made to the preceding embodiments, and the details are not repeated here. With reference to FIG. 6, the apparatus includes an acquisition module 61 and a control module 62.

The acquisition module 61 is configured to acquire first power control assistance information included in power control assistance information, and the control module 62 is configured to perform power control on a first node.

The information transmission apparatus provided in this embodiment is configured to implement the information transmission method in the embodiment shown in FIG. 3. The implementation principles and effects of the information transmission apparatus provided in this embodiment are similar to those of the information transmission method in the embodiment shown in FIG. 3, and the details are not repeated here.

Based on the preceding embodiment, variant embodiments of the preceding embodiment are provided. For the brevity of description, only differences from the preceding embodiment are described in the variant embodiments.

In an embodiment, the apparatus further includes a sending module.

The transmission module is configured to transmit the first power control assistance information to a third node.

In an embodiment, the first power control assistance information is acquired from the first node or the third node.

In an embodiment, the third node acquires the first power control assistance information from the first node.

In an embodiment, the apparatus further includes a second power control assistance information acquisition module.

The second power control assistance information acquisition module is configured to acquire second power control assistance information.

In an embodiment, the second power control assistance information is acquired from the first node or the third node.

In an embodiment, the third node acquires the second power control assistance information from the first node.

In an embodiment, the apparatus further includes a transmission module.

The transmission module is configured to transmit the second power control assistance information to the third node.

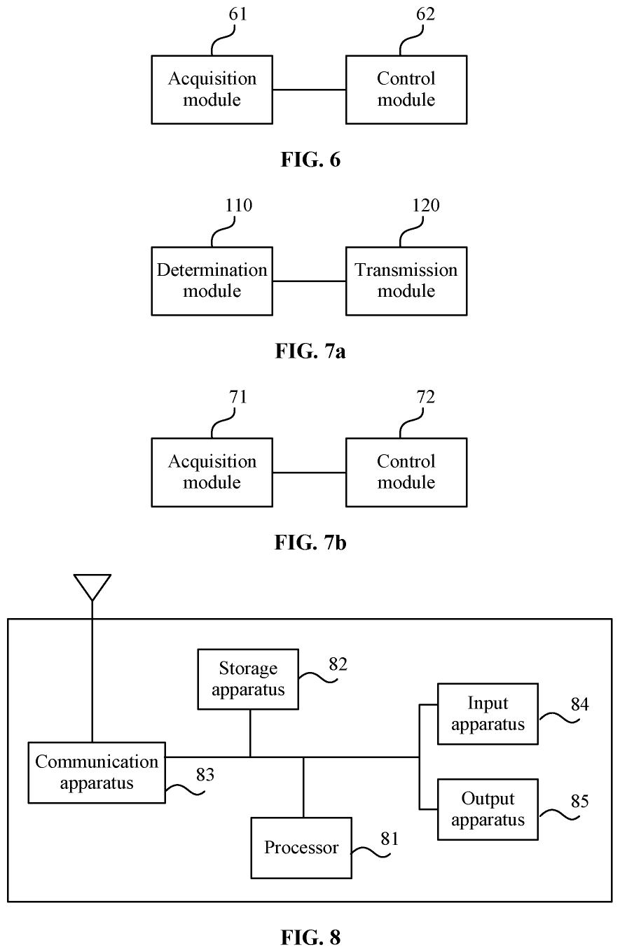

In an example implementation, the present application provides an information transmission apparatus. FIG. 7a is a structure diagram of another information transmission apparatus according to an embodiment of the present application. The apparatus is integrated into a first node. With reference to FIG. 7a, the apparatus includes a determination module 110 and a transmission module 120.

The determination module 110 is configured to determine power control assistance information, where the power control assistance information includes second power control assistance information. The transmission module 120 is configured to transmit the power control assistance information.

The information transmission apparatus provided in this embodiment is configured to implement the information transmission method in the embodiment shown in FIG. 4a. The implementation principles and effects of the information transmission apparatus provided in this embodiment are similar to those of the information transmission method in the embodiment shown in FIG. 4a, and the details are not repeated here.

Based on the preceding embodiment, variant embodiments of the preceding embodiment are provided. For the brevity of description, only differences from the preceding embodiment are described in the variant embodiments.

In an embodiment, the apparatus includes one of:
one multiplexing manner corresponds to one piece of second power control assistance information;
one multiplexing manner and one uplink transmission type correspond to one piece of second power control assistance information; one uplink transmission timing corresponds to one piece of second power control assistance information; one uplink transmission timing and one uplink transmission type correspond to one piece of second power control assistance information; one time domain resource corresponds to one piece of second power control assistance information; one time domain resource and one uplink transmission type correspond to one piece of second power control assistance information; one timing mode corresponds to one piece of second power control assistance information; or one timing mode and one uplink transmission type correspond to one piece of second power control assistance information.

In an example implementation, the present application provides an information transmission apparatus. FIG. 7b is a structure diagram of yet another information transmission apparatus according to an embodiment of the present application. The apparatus is configured in a second node. For the content that is not yet exhaustive in this embodiment, reference may be made to the preceding embodiments, and the details are not repeated here. With reference to FIG. 7b, the apparatus include an acquisition module 71 and a control module 72. The acquisition module 71 is configured to acquire second power control assistance information included in power control assistance information. The control module 72 is configured to perform power control on a first node.

The information transmission apparatus provided in this embodiment is configured to implement the information transmission method in the embodiment shown in FIG. 4b. The implementation principles and effects of the information transmission apparatus provided in this embodiment are similar to those of the information transmission method in the embodiment shown in FIG. 4b, and the details are not repeated here.

Based on the preceding embodiment, variant embodiments of the preceding embodiment are provided. For the brevity of description, only differences from the preceding embodiment are described in the variant embodiments.

In an embodiment, the apparatus includes one of:
one multiplexing manner corresponds to one piece of second power control assistance information; one multiplexing manner and one uplink transmission type correspond to one piece of second power control assistance information; one uplink transmission timing corresponds to one piece of second power control assistance information; one uplink transmission timing and one uplink transmission type correspond to one piece of second power control assistance information; one time domain resource corresponds to one piece of second power control assistance information; one time domain resource and one uplink transmission type correspond to one piece of second power control assistance information; one timing mode corresponds to one piece of second power control assistance information; or one timing mode and one uplink transmission type correspond to one piece of second power control assistance information.

In an example implementation, the present application provides a node. FIG. 8 is a structure diagram of a node according to an embodiment of the present application. The node may be a first node executing the method shown in FIG. 1 or FIG. 4a or may be a second node executing the method shown in FIG. 3 or FIG. 4b. As shown in FIG. 8, the node provided by the present application includes one or more processors 81 and a storage apparatus 82. One or more processors 81 may be provided in the node, and one processor 81 is illustrated as an example in FIG. 8. The storage apparatus 82 is configured to store one or more programs, and the one or more programs are executed by the one or more processors 81 to cause the one or more processors 81 to implement the information transmission method in the embodiments of the present application.

The node also includes a communication apparatus 83, an input apparatus 84, and an output apparatus 85.

The processor 81, the storage apparatus 82, the communication apparatus 83, the input apparatus 84 and the output apparatus 55 in the node may be connected via a bus or other means, and connection via a bus is performed by way of example in FIG. 8.

The input apparatus 84 may be used for receiving input digital or character information and generating keying signal input related to user settings of the node and function control of the node. The output apparatus 85 may include a display device such as a display screen.

The communication apparatus 83 may include a receiver and a transmitter. The communication apparatus 83 is configured to perform information transceiving and communication under the control of the processor 81. The information includes, but is not limited to, power control assistance information.

As a computer-readable storage medium, the storage apparatus 82 may be configured to store software programs, computer-executable programs and modules, such as program instructions/modules (for example, the determination module 51 and the transmission module 52 in the information transmission apparatus; the acquisition module 61 and the control module 62 in the information transmission apparatus; and the acquisition module 71 and the control module 72 in the information transmission apparatus) corresponding to the information transmission method in the embodiments of the present application. The storage apparatus 82 may include a program storage region and a data storage region. The program storage region may store an operating system and an application program required by at least one function. The data storage region may store data created depending on the use of the node. Additionally, the storage apparatus 92 may include a high-speed random-access memory and may also include a non-volatile memory such as at least one disk memory, a flash memory device or another non-volatile solid-state memory. In some examples, the storage apparatus 82 may include memories which are remotely disposed with respect to the processor 81. These remote memories may be connected to the network node via a network. Examples of the preceding network include, but are not limited to, the Internet, an intranet, a local area network, a mobile communication network, and combinations thereof.

An embodiment of the present application further provides a storage medium. The storage medium is configured to store a computer program, and the computer program, when executed by a processor, implements any information transmission method provided by the present application. The storage medium is configured to store a computer program, and the computer program, when executed by a processor, implements the information transmission method in any one of the embodiments of the present application, such as the information transmission method applied to the first node and the information transmission method applied to the second node. The information transmission method applied to the first node includes: power control assistance information is determined, and the power control assistance information is transmitted, where the power control assistance information includes first power control assistance information, and the first power control assistance information includes an expected transmit power spectral density. The information transmission method applied to the second node includes: first power control assistance information included in power control assistance information is acquired, and power control is performed on the first node. The information transmission method applied to the second node includes: second power control assistance information included in power control assistance information is acquired, and power control is performed on the first node.

A computer storage medium in the embodiments of the present application may adopt any combination of one or more computer-readable media. The computer-readable medium may be a computer-readable signal medium or a computer-readable storage medium. The computer-readable storage medium may be, but is not limited to, an electrical, magnetic, optical, electromagnetic, infrared or semiconductor system, apparatus or device, or any combination thereof. Examples (a non-exhaustive list) of the computer-readable storage medium include: an electrical connection having one or more wires, a portable computer magnetic disk, a hard disk, a random-access memory (RAM), a read-only memory (ROM), an erasable programmable read-only memory (EPROM), a flash memory, an optical fiber, a portable compact disc read-only memory (CD-ROM), an optical memory device, a magnetic memory device, or any suitable combination thereof. The computer-readable storage medium may be any tangible medium that can contain, or store a program for use by or in connection with an instruction execution system, apparatus, or device.

The computer-readable signal medium may include a propagated data signal with computer-readable program codes embodied therein, for example, in a baseband or as a part of a carrier wave. Such a propagated signal may take any of a variety of forms, including, but not limited to, electro-magnetic, optical, or any suitable combination thereof. The computer-readable signal medium may be any computer-readable medium that is not a computer-readable storage medium and that can communicate, propagate, or transport a program for use by or in connection with an instruction execution system, apparatus, or device.

The program codes included on the computer-readable medium may be transmitted via any suitable medium which includes, but is not limited to, a wire, an optical cable, a radio frequency (RF), or any suitable combination thereof.

Computer program codes for performing the operations of the present application may be written in one or more programming languages or a combination of multiple programming languages. The programming languages include object-oriented programming languages such as Java, Smalltalk, and C++ and may further include conventional procedural programming languages such as “C” or similar programming languages. The program codes may be executed entirely on a user computer, partly on a user computer, as a stand-alone software package, partly on a user computer and partly on a remote computer, or entirely on a remote computer or a server. In the scenario involving the remote computer, the remote computer may be connected to the user computer through any type of network, including a local area network (LAN) or a wide area network (WAN), or may be connected to an external computer (for example, through the Internet using an Internet service provider).

The above are only example embodiments of the present application.

It is to be understood by those skilled in the art that the term terminal device encompasses any appropriate type of radio user device, such as a mobile phone, a portable data processing apparatus, a portable web browser, or a vehicle-mounted mobile station.

In general, the various embodiments of the present application may be implemented in hardware or special-purpose circuits, software, logic or any combination thereof. For example, some aspects may be implemented in hardware while other aspects may be implemented in firmware or software that may be executed by a controller, a microprocessor, or other computing apparatuses, though the present application is not limited thereto.

The embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, status setting data, or source or object codes written in any combination of one or more programming languages.

A block diagram of any logic flow among the drawings of the present application may represent program steps, may represent interconnected logic circuits, modules, and functions, or may represent a combination thereof. Computer programs may be stored on a memory. The memory may be of any type suitable for a local technical environment and may be implemented using any suitable data storage technology, such as, but not limited to, an ROM, an RAM, and an optical memory apparatus and system (digital video disc (DVD) or compact disk (CD)). The computer-readable medium may include a non-transitory storage medium. The data processor may be of any type suitable to the local technical environment such as, but not limited to, a general-purpose computer, a special-purpose computer, a microprocessor, digital signal processing (DSP), an application-specific integrated circuit (ASIC), a field-programmable gate array (FPGA) and a processor based on a multi-core processor architecture.

1. An information transmission method, applied to a first node and comprising:
determining power control assistance information; and
transmitting the power control assistance information,
wherein the power control assistance information comprises an expected transmit power spectral density.

2. The information transmission method of claim 1, wherein the expected transmit power spectral density comprises an expected transmit power range per frequency unit.

3. The information transmission method of claim 1, wherein:
one multiplexing manner corresponds to the power control assistance information; or
one time domain resource corresponds to the power control assistance information.

4. The information transmission method of claim 1, comprising transmitting the power control assistance information to a parent node of the first node.

5. The information transmission method of claim 3, wherein the one multiplexing manner comprises the first node performing:
mobile termination (MT) transmission and distributed unit (DU) transmission simultaneously; or
MT reception and DU reception simultaneously; or
MT reception and DU transmission simultaneously; or
MT transmission and DU reception simultaneously.

6. A first node, comprising:
at least one processor configured to:
determine power control assistance information; and
transmit, via a transmitters, the power control assistance information,
wherein the power control assistance information comprises an expected transmit power spectral density.

7. The first node of claim 6, wherein the expected transmit power spectral density comprises an expected transmit power range per frequency unit.

8. The first node of claim 6, wherein:
one multiplexing manner corresponds to the power control assistance information; or
one time domain resource corresponds to the power control assistance information.

9. The first node of claim 6, wherein the at least one processor configured to transmit, via the transmitter, the power control assistance information to a parent node of the first node.

10. The first node of claim 8, wherein the one multiplexing manner comprises the first node performing:
mobile termination (MT) transmission and distributed unit (DU) transmission simultaneously; or
MT reception and DU reception simultaneously; or
MT reception and DU transmission simultaneously; or
MT transmission and DU reception simultaneously.

11. An information transmission method, applied to a parent node of a first node, and comprising:
receiving power control assistance information,
wherein the power control assistance information is determined by the first node, and comprises an expected transmit power spectral density.

12. The information transmission method of claim 11, wherein the expected transmit power spectral density comprises an expected transmit power range per frequency unit.

13. The information transmission method of claim 11, wherein:
one multiplexing manner corresponds to the power control assistance information; or
one time domain resource corresponds to the power control assistance information.

14. The information transmission method of claim 11, comprising receiving the power control assistance information from the first node.

15. The information transmission method of claim 13, wherein the one multiplexing manner comprises the first node performing:
mobile termination (MT) transmission and distributed unit (DU) transmission simultaneously; or
MT reception and DU reception simultaneously; or
MT reception and DU transmission simultaneously; or
MT transmission and DU reception simultaneously.

16. A parent node of a first node, comprising:
at least one processor configured to:
receive, via a receiver, power control assistance information,
wherein the power control assistance information is determined by the first node, and comprises an expected transmit power spectral density.

17. The parent node of claim 16, wherein the expected transmit power spectral density comprises an expected transmit power range per frequency unit.

18. The parent node of claim 16, wherein:
one multiplexing manner corresponds to the power control assistance information; or
one time domain resource corresponds to the power control assistance information.

19. The parent node of claim 16, wherein the at least one processor is configured to receive the power control assistance information from the first node.

20. The parent node of claim 18, wherein the one multiplexing manner comprises the first node performing:
mobile termination (MT) transmission and distributed unit (DU) transmission simultaneously; or
MT reception and DU reception simultaneously; or
MT reception and DU transmission simultaneously; or
MT transmission and DU reception simultaneously.
